(19) United States
(12) Patent Application Publication
(10) Pub. No.: US 2014/0278722 A1
(43) Pub. Date: Sep. 18, 2014

(54) CUSTOMIZABLE SAAS-BASED REDEMPTION SYSTEM AND METHOD

(71) Applicant: GIZMO CREATIVE, INC., Carmel Valley, CA (US)

(72) Inventors: Daniel Duerr, Carmel Valley, CA (US); Simon Welter, Madisonville, TN (US)

(73) Assignee: GIZMO CREATIVE, INC., Carmel Valley, CA (US)

(21) Appl. No.: 14/214,530

(22) Filed: Mar. 14, 2014

Related U.S. Application Data
(60) Provisional application No. 61/793,219, filed on Mar. 15, 2013.

(51) Int. Cl. G06Q 30/02; G06Q 10/06

(52) U.S. Cl. CPC G06Q 30/0222; G06Q 10/06316
USPC 705/7.26

(57) ABSTRACT

An example embodiment includes a method of fulfilling a redemption request. The method includes creating an offer for an entity. The offer is configured to incentivize a purchase of a good or a service of the entity. The method includes distributing the offer to customers via at least one e-commerce channel. The method includes collecting payment for a purchase of the good or the service from a customer. In response to collection of the payment, the method includes generating a redemption request. The method further includes tracking the redemption request according to a customized workflow process of the entity. The customized workflow process includes subroutines selected by the entity.

### CROSS REFERENCE TO RELATED APPLICATIONS

This application claims the benefit of and priority to U.S. Provisional Application No. 61/793,219 which is incorporated herein by reference in its entirety.

### FIELD

Embodiments described herein relate to a customizable redemption for goods or services purchased or otherwise obtained by a customer.

### BACKGROUND

Improvements in technology have provided customers with greater opportunities for engaging in commerce. For example, with the widespread use of internet sales and marketing, more customers turn online to do their shopping and business. One aspect of online sales and marketing, however, is that there can be a disconnect for a merchant between the e-commerce system which is used to market and capture sales and the ability to monitor and/or deliver the goods or services once the sale has occurred.

Similar difficulties arise in point-of-sale systems (POS) systems. In POS systems, even though a customer may be physically present in the store, the desired good or service may not yet be in the customer's possession. For example, a customer may use a POS register in a restaurant to pay for an item, such as a pizza. In return, the POS, which handles the sale then generates a request which is transmitted to the kitchen of the restaurant, indicating that a pizza has been paid for and needs to be prepared and delivered.

In each of these systems, a fully customized system which handles both the sale and the delivery of goods can be expensive to purchase or develop. This is particularly burdensome for smaller entities which desire the advantages of having an integrated sales, inventory, and delivery or redemption system without spending the large amount of capital involved in obtaining a customized software and hardware solution. Due to this large expense, it is often difficult for smaller entities to adequately compete with their larger counterparts.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

According to an aspect of an embodiment, an example embodiment includes a method of fulfilling a redemption request. The method includes creating an offer for an entity. The offer is configured to incentivize a purchase of a good or a service of the entity. The method includes distributing the offer to customers via at least one e-commerce channel. The method includes collecting payment for a purchase of the good or the service from a customer. In response to collection of the payment, the method includes generating a redemption request. The method further includes tracking the redemption request according to a customized workflow process of the entity. The customized workflow process includes subroutines selected by the entity.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE FIGURES

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram which illustrates an example system in which some embodiments may be implemented;

FIG. 2 is a flow diagram illustrating an example method of fulfilling a redemption request;

FIG. 3 is a flow diagram illustrating another example method of fulfilling a redemption request;

FIG. 4 is a flow diagram illustrating another example method of fulfilling a redemption request;

FIGS. 5-12 are example screenshots which illustrate aspects of an example user interface associated with a redemption system implemented in the system of FIG. 1; and

FIG. 13 illustrates an embodiment of a computing system arranged for performing a redemption process,

all arranged in accordance with at least one embodiment described herein.

### DETAILED DESCRIPTION

Some embodiments described herein relate to a customizable SaaS-based redemption system (redemption system) and method which, as described more fully below, may be added or “bolted” onto an existing sales or transaction process. For example, the redemption system may be bolted onto an e-commerce, an online sales system, a POS system or a system including one or more of the e-commerce, the online sales system, and the POS system. Some embodiments provide one or more merchants with the ability to create customized redemption systems. The customized redemption systems may be capable of working with existing sales systems of the merchants to create a customizable workflow based on the particular needs of each of the merchants.

In some instances, the customizable aspects of the system include the ability to create additional security steps or measures. In other instances, the merchant, or more generally an entity, is able to vary and control the authorization levels of operators of the redemption system to perform one or more tasks and/or view different aspects of the redemption system. The entity may also be able to create and/or modify a specific workflow process used by the entity. Furthermore, the customizable aspects of the invention also enable the entity to add or modify inventory control or management steps or processes.

Some embodiments described herein may also be scalable. For example, the entity can add one or more operators to the redemption systems and/or add workflow subroutines as necessary for the entity to manage its redemption process.

One benefit of the redemption system is that entities can easily create a customized redemption system which enables the entity to track inventory and/or perform functions which may help the entities ensure that a redemption request is properly fulfilled. Additionally, some embodiments described herein are easily modified and scaled according to needs of the entity. Rather than the entity obtaining an entirely new system as the demands of the entity changes, the redemption system may simply be updated and modified as the needs change. For example, as the entity grows, the redemption system may be periodically or constantly changed and updated so as to add additional operators to the system, each with varying authorization rights. Similarly, as inventory of the entity grows, the redemption system may be updated to add additional inventory or security measures which enable the entity to more accurately monitor and deliver goods or services to customers.

An advantage of some embodiments of the redemption system may include enabling smaller entities, which may not otherwise be able to afford a customizable redemption system, access to a customized redemption system. By providing this service, the smaller entities may be better suited to compete with larger competitors that may have a large-scale, customized redemption system.

FIG. 1 illustrates an example system 100 in which one or more embodiments described herein may be implemented. The system 100 described in FIG. 1 is illustrative only. The present disclosure applies to systems including different components, existing components that are combined or separated without departing from the meaning and scope of the claims.

In the system 100 of FIG. 1, an entity 130 connects to a redemption system 150 via a network 120. Customers and potential customers 105a-105d (generally, customer 105 or customers 105) also connect to the entity 130 via the network 120. In this example, the entity 130 has a sales module 132, which, for example, may include a POS system 133 and/or e-commerce system 131, which one or more of the customers 105 may use to purchase a product or service over the network 120.

As shown in FIG. 1, the sales module 132 may be connected or tied to a physical inventory 134 of goods and may operate using a memory database 136 and a processor 138.

In some embodiments, the e-commerce system 131 is connected to customers 105 via the network 120. The network 120 may be the Internet or other network capable of enabling the customers 105 to engage in an electronic transaction with the entity 130. Various different e-commerce systems 131 may be used, including websites which include online shopping carts, which allow a customer 105 to browse a selection of available goods or services and select one or more goods and services for purchase or redemption.

The e-commerce systems 131 may include a user interface. Selections by the customer 105 and/or customer payment information may be received via the customers 105 interfacing or interacting with the user interface. In some instances, a payment may be in the form of a credit card, debit card, cash, PayPal®, or other suitable monetary payments. Additionally or alternatively, the payment may be in the form of redemption of rewards points or the like. In instances where a credit card is used, the sales module 132 may be used in conjunction with a secure payment gateway, in order to conduct secure credit card transactions online.

In some embodiments, the sales module 132 may be operated by the entity 130. In these and other embodiments, the entity 130 may use a processor 138 and memory database 136 in association with an entity server (not shown) to host a website. In these instances, shopping cart software may be installed on the entity server which hosts the site, or on the secure server which accepts sensitive ordering information and may be implemented using HTTP cookies or query strings.

In embodiments in which the entity operates the sales module 132, the system 100 may be accessed and/or used for a one-time fee. Additionally or alternatively, one or more functionalities of the system 100 or redemption system 150 may be provided to the entity for free. An advantage of the systems 100 in which the entity 130 has control over the sales module 132 may include that the entity 130 may modify the sales module 132 as necessary. A disadvantage of the system 100 may include a cost associated with developing and maintaining the HTTP code or other components developed and/or supporting the sales module 132. For example, developing and providing support for an online e-commerce system (e.g., including e-Commerce 131) for the sales module 132 may include ensuring that online transactions are adequately secured, maintaining personal or payment information from unwanted third parties, and ensuring that the code is adequately compatible with different browsers used by the customers 105.

Alternatively, a hosted service provider may be used to provide and maintain the sales module 132. In these and other embodiments, the hosted service provider may use predefined templates that the entity 130 can choose from to customize its look and feel. Predefined templates limit how much the entity 130 can modify or customize the software with the advantage of having the vendor keep the software up to date for security patches as well as adding new features.

As described below, in the embodiments described herein, the entity 130 uses a redemption system 150 to track and monitor the creation and fulfillment of redemption requests to ensure that the redemption of offers provided by the sales module 132 are fulfilled.

In some embodiments, a third party or an operator of the redemption system 150 described more fully below may provide the entity 130 with an application programming interface (API) or another hosted sales module 132. The API and/or the other hosted sales module 132 may operate as a plug-in or other hosted web service. The entity 130 may subscribe to or purchase the API or hosted web service. In these and other embodiments, the sales module 132 may appear to be operated by the entity 130 to the customer 105. However, processes involved in any transaction between the customers 105 and the entity 130 may actually be performed by the redemption system 150 or other third party. The redemption system 150 or other third party may notify the entity 130 that a sale or transaction has occurred.

A benefit of a third party hosted sales module 132 is that the entity 130 is not required to expend the costs necessary to operate or maintain the sales module 132. This may be advantageous to smaller entities that may like the ability to offer online sales to customers 105 while maintaining lower operation expenses.

In other embodiments, the entity 130 may operate the sales module 132 themselves and utilize the redemption system 150 in association with the sales module 132 Through operation of the sale module, the entity 130 may fulfill redemption requests using a customized workflow.

In some instances, the customers 105 may connect to the sales module 132 via a POS system 133 operated by or in association with the entity 130. The POS system 133 may include a terminal which is connected to the sales module 132 via the network 120. This configuration may include a physical POS terminal which may include a cash register and may combined software, hardware, and peripheral devices. In some instances, the POS terminal of the POS system 133 may be physically located within a store or another enterprise owned or operated by the entity 130. The POS terminal may have a sales associate or cashier assisting and supervising transactions occurring at the POS terminal. Some POS systems 133 may have stations provided for the customer 105 to check themselves out by scanning and/or selecting their own items. The customer 105 may then pay with a debit or credit card, for example. A selection of the customer 105 is then transferred from the POS system 133 to the sales module 132 via the network 120, which in turn communicates with the redemption system 150 as described herein.

The redemption system 150 includes a processor 158 and memory 152. The processor 158 and the memory 152 operate together to provide a system which may be used or “bolted-on” the sales module 132. For example, the redemption system 150 may provide a customizable workflow for enabling the entity 130 to fulfill the sales and/or transaction redemption requests created by the sales module 132.

Using a user interface, the entity 130 can customize a workflow based on one or more particular needs of the entity 130 using the redemption system 150. For example, additional security, workflow processes, inventory control or any combination thereof can be added to the customized workflow as desired by the entity 130.

In addition, the redemption system 150 may include an authorization module 154. The authorization module 154 may be used to control a number of operators that can use the redemption system 150 from the entity 130. Additionally, the authorization module 154 may enable the entity 130 to control specific permissions assigned to each operator.

The redemption system 150 may also include a publishing module 156 which enables the entity 130 to create offers. The offers may include entity funded incentives, promotions, coupons, specials, or the like. For example, the publishing module 156 may be used to offer a coupon for a percentage off the purchase price of a good or service. In this instance, a customer 105 may receive the offer through a variety of marketing channels and may redeem the coupon at the time that the good or the service was purchased. The marketing channels can include, but are not limited to, e-marketing channels such as e-mails, web advertisements, social media links, and the like. Traditional marketing channels such as mailers, billboards, etc. can also be used. In some embodiments, the customer 105 may redeem the offer at or after the time of purchase.

In other instances, the publishing module 156 may be configured to provide offers, where the payment is collected prior to the point of redemption. For example, the publishing module 156 may offer a gift certificate for a good or service offered by the entity 130 through a variety of marketing channels. The customer 105 may pay for the gift certificate in advance using the sales module 132 and subsequently redeem the gift certificate by purchasing goods or services using the sales module 132. The sales module 132 may in turn use the redemption system 150 to ensure that the goods or services are properly redeemed.

FIG. 2 is a flow chart that illustrates an example method 200 for fulfilling a redemption request according to at least one embodiment described herein. The method 200 may be programmably performed in some embodiments by the redemption system 150 described with reference to FIG. 1. Additionally or alternatively, the method 200 may be programmably performed by the entity 130 of FIG. 1. The redemption system 150 and/or the entity 130 may include or may be communicatively coupled to a non-transitory computer-readable medium (e.g., the memory 152 or 136 of FIG. 1) having stored thereon or encoded therein programming code or instructions that are executable by a processor to perform or cause performance of the method 200. The redemption system 150 and/or the entity 130 may include the processors 158 and 138, respectfully that are configured to execute computer instructions to cause or control performance of the method 200. Although illustrated as discrete blocks, various blocks may be divided into additional blocks, combined into fewer blocks, or eliminated, depending on the desired implementation.

In the embodiment of FIG. 2, the method 200 begins at 210. At 210, a generic user offer may be created. For example, with reference to FIG. 1, the entity 130 may create a generic offer. The generic offer may be created using the publishing module 156 of the redemption system 150. In some instances, the generic offer may include a unique offer identification number and/or scanable quick response (QR) code.

At 220, the generic offer may be advertised to customers. For example, with reference to FIG. 1, the generic offer may be advertised to the customers 105 via a variety of marketing channels. In some instances, the one or more of the customers 105 may utilize a same offer identification number or scanable QR code.

At 230, a customer may present the offer identification number. For example, with reference to FIG. 1, the customer 105 may present the offer identification number, QR code, or other generic offer identifier to the entity 130 using either the redemption system 150 or the sales module 132. More particularly, in some instances the customer 105 may redeem the generic offer using the sales module 132 operated by the entity 130 or other third party associated with the entity 130 that operates the sales module 132, either using an e-commerce system 131 or a POS system 133, for instance.

At 240, payment may be collected and a redemption request may be created. For example, with reference to FIG. 1, the sales module 132 may collect payment from the customer 105. Additionally or alternatively, the redemption system 150 may create a redemption request. In some instances, the sales module 132 may create the redemption request and then subsequently send it to the redemption system 150. In other instances, the sales module 132 may simply notify the redemption system 150 that a purchase has been made, causing the redemption system 150 to generate the request.

In some embodiments, prior to the collection of payment and/or creation of a redemption request, the sales module 132 may verify and/or authorize the generic offer using the authorization module 154 and/or the publishing module 156 of the redemption system 150.

After the redemption request has been created at 240, the method 200 may continue to 250. At 250, the redemption request may be tracked according to a customized workflow process. For example, with reference to FIG. 1, the sales module 132 may track the redemption request using the redemption system 150 according to the merchant's customized workflow process.

At 260, it may be determined whether the redemption request has been completed. In response to the redemption request not being completed (“No” at 260), the method 200 may proceed to 250. In response to the redemption request being completed (“Yes” at 260), the method 200 may proceed to block 210 and repeat one or more of 210, 220, 230, 240, 250, and 260. Some examples of the customized workflow process and features thereof are described more below. In some instances, the customized workflow process may involve the use of API calls, notifications, or requests and web-based input prompts being sent to customers and/or users or employees of the entity 130.

FIG. 3 is a flow chart which illustrates another example method 300 for creating and fulfilling a redemption request. The method 300 may be programmably performed in some embodiments by the redemption system 150 described with reference to FIG. 1. Additionally or alternatively, the method 300 may be programmably performed by the entity 130 of FIG. 1. The redemption system 150 and/or the entity 130 may include or may be communicatively coupled to a non-transitory computer-readable medium (e.g., the memory 152 or 136 of FIG. 1) having stored thereon or encoded therein programming code or instructions that are executable by a processor to perform or cause performance of the method 300. The redemption system 150 and/or the entity 130 may include the processors 158 and 138, respectfully that are configured to execute computer instructions to cause or control performance of the method 300. Although illustrated as discrete blocks, various blocks may be divided into additional blocks, combined into fewer blocks, or eliminated, depending on the desired implementation.

The method 300 may begin at 310. At 310, a template offer may be created. The template offer may include a unique offer uniform resource locator (URL). For example, with reference to FIG. 1, the entity 130 may create a template offer with a unique offer website or URL using the publishing module 156 of the redemption system 150. In some instances, the template offer includes generalized aspects which are shown to many customers 105 of the system 100, but which includes a unique offer opt in URL which may be unique to each customer 105.

At 320, the template offer may be advertised to customers. For example, with reference to FIG. 1, the template offer may be distributed to customers 105 via traditional and various e-marketing channels. At 330, an opt in message may be received at the unique offer URL. For example, with reference to FIG. 1, a customer 105 may go to the offer opt in URL to complete an “opt in process.” In response, the publishing module 156 generates a unique instance of the offer referred to as a customer-specific offer that is tied to the individual customer 105. The opt in process may involve associating the offer with a credit card or other financial account of the individual customer 105. At 350, a redemption of the customer-specific off may be received. For example, with reference to FIG. 1, the customer 105 may redeem the offer by presenting her credit card or other identifier to sales module 132 of the entity 130 for offer lookup and validation via the authorization module 154 and/or publishing module 156 of the redemption system 150 or by directly interacting with the redemption system 150. For example, the credit card may be used at the sales module 132 so as to retrieve the appropriate offer.

At 360, payment may be collected and a redemption request may be created. For example, with reference to FIG. 1, the sales module 132 may collect payment, complete the sale, and create a redemption request. At 370, the redemption request may be tracked. For example, with reference to FIG. 1, the sales module 132 may track the completion of the sale through a series of API calls, notifications, requests, and/or web-based prompts according to the merchant's customized workflow at the redemption system 150. At 380, it may be determined whether the redemption request has been completed. In response to the redemption request not being completed (“No” at 380), the method 300 may proceed to 270. In response to the redemption request being completed (“Yes” at 380), the method 300 may proceed to block 310 and repeat one or more of 310, 320, 330, 340, 350, 360, 370, and 380.

FIG. 4 is a flow chart of another example method 400 of creating and fulfilling an example redemption request. The method 400 may be programmably performed in some embodiments by the redemption system 150 described with reference to FIG. 1. Additionally or alternatively, the method 400 may be programmably performed by the entity 130 of FIG. 1. The redemption system 150 and/or the entity 130 may include or may be communicatively coupled to a non-transitory computer-readable medium (e.g., the memory 152 or 136 of FIG. 1) having stored thereon or encoded therein programming code or instructions that are executable by a processor to perform or cause performance of the method 400. The redemption system 150 and/or the entity 130 may include the processors 158 and 138, respectfully that are configured to execute computer instructions to cause or control performance of the method 400. Although illustrated as discrete blocks, various blocks may be divided into additional blocks, combined into fewer blocks, or eliminated, depending on the desired implementation.

At 410, goods and services may be offered for purchase. For example, with reference to FIG. 1, the entity 130 may offer goods and/or services for purchase using an e-commerce system 131 of a sales module 132. At 420, a selection of “in store pickup” may be received. For example, with reference to FIG. 1, a customer 105 makes a purchase using the e-commerce system 131. During or after the purchase, the customer 105 may select an “in store pickup” whereby the customer 105 elects to receive the purchased good or service at a store owned or operated by or in association with the entity 130.

At 430, payment may be collected and a redemption request may be created. For example, with reference to FIG. 1, the sales module 132 collects payment and creates a redemption request. At 440, the redemption request may be tracked. For example, with reference to FIG. 1, the redemption request may be tracked and processed using the redemption system 150 at step 440a according to a customized workflow of the entity 130. In some instances, tracking the redemption request may include sending notifications or other alerts to the customer 105, including creating a unique item identification number or scanable QR code which is sent to the customer 105 in an e-mail, text, phone call, or other notification means for use in tracking or monitoring the redemption process. A receipt of the purchase may also be sent to the customer 105 during this process.

The customer 105 may use the item ID or QR code to track the redemption process by presenting the item ID or QR code to the sales module 132 of the entity 130, which in turn communicates with the redemption system 150 to determine the status of the redemption request. In other instances, the customer 105 may interact directly with the redemption system 150 via a customer 105 interface which has some subset of viewing or monitoring abilities.

At 450, a customer may be notified of a status of the redemption request. For example, the redemption system 150 may notify the customer 105 that the good or service is ready for pickup or redemption at a store.

At 460, it may be determined whether the redemption request has been completed. In response to the redemption request not being completed (“No” at 460), the method 400 may proceed to 440. In response to the redemption request being completed (“Yes” at 460), the method 400 may proceed to block 410 and repeat one or more of 410, 420, 430, 440, 450, and 460. For example, after pickup, the redemption system 150 determines at 460 that the redemption is complete and the process concludes until more goods or services are made available at 410 and/or another customer makes a purchase 420.

In some configurations, the redemption system 150 or sales module may act as an e-commerce payment system, which collects funds from customers 105 and temporarily stores the funds until an electronic transfer of the funds is completed and until the entity 130 is determined as having fulfilled the redemption request. Additionally or alternatively, in some embodiments, if the entity 130 fails to fulfill the redemption request, then the redemption system 150 may refund collected money to the customer 105.

FIGS. 5-12 illustrate example portions of a user interface as a series of screenshots 500, 600, 700, 800, 900, 1000, 1100, and 122. Generally, users associated with the entity 130 may interface with the user interface to track a redemption request.

FIG. 5 is a screenshot 500 of a portion of an example user interface that includes various functions, including a dashboard button 514, which directs the user to a dashboard or a control page. The dashboard or the control page may indicate items having urgent actions at the top of the page, moving into less important statistics or actions at the bottom of the page. A settings button 516 may direct a user to a page that enables the user to monitor or customize settings regarding the display of information in the screenshot 500. Additionally or alternatively, depending on the authorization level of the user, the settings button 516 may also enable the user to add or modify the steps of a customized workflow process.

A workflow button 518 directs the user to a control panel where the user is able to view where various redemption requests are in the workflow process. A locations button 520 enables the user to store or monitor inventory at various locations. The location button 520 or functionalities provided thereby may be beneficial in instances where an entity (e.g., 130 of FIG. 1) has inventory located at various locations and wishes to monitor or control which location fulfills each redemption request.

If the user is an administrator or other user with the necessary permission level, the user may be able to select or modify which workflow steps are monitored by the system. For example, while an example workflow process involves the general steps of one or more of the steps in methods 200, 300, and 400 additional steps may be added so as to more closely tailor the redemption system 150 to the needs of a particular entity 130.

For example, additional steps may include inventory sub-routines such as locating the necessary goods, ordering the goods if a determination is made that they are not currently in stock, retrieving the goods from a warehouse, etc. In instances where a good is being manufactured or produced, additional workflow steps may involve ordering the raw goods necessary to generate the final goods, delivering the raw goods to an employee which creates the final goods, inspecting the goods, packaging the goods, shipping the goods, and the like. In embodiments where a service is to be rendered, additional sub-routines may involve identifying a service employee capable of performing the necessary service, monitoring the docket or schedule of servicemen, and the like. Some other additional workflow steps may involve security such as verifying the identity of a customer authorized to pick up the goods or service by obtaining a signature, verifying identification, and the like.

Returning to FIG. 5, a summary button 522 directs the user to a summary page, which may include a list of actions that need to be fulfilled or most urgent actions, a summation of how many redemption requests are outstanding, a listing of where and how many redemption requests are currently at each of the various workflow stages and the like. A user profile page 524 may direct the user to a page where the user is able to access various user information, such as a list of employees by employee number and the like.

A user log button 526 directs a user to a listing of previous actions performed by the user or various users of the system. A permissions button 528 is available to an administrator of the system, such that the administrator is able to add or modify which users are able to access the system, and what operations each user is able to perform when accessing the redemption system 150.

For example, an administrator may be able to add or edit the permissions of various users or operators of the system by setting their permission levels. As such, the redemption system 150 is customizable and scalable in that it is able to support various different types of operators so that they have access levels which correspond to their respective roles. Examples of user roles include managers, associates, owners, administrators, employees, and the like.

The screenshot 500 in this example includes a welcome screen 510, which includes a summary of which user is logged into the system, and an “At a Glance” window which illustrates all the pending matters which need review by the user logged into the system. On a left portion of the screen 500 a workflow summary is shown which includes a window showing the number of new redemption requests 502 since the user last logged in, a button indicating the number of redemption requests which are ready to be pulled from inventory 504, and a button indicating the number of redemption requests which are pending pickup 506.

The screenshot 500 also includes a quick scan screen 512 which may be used in association with a bar code scanner, such as a QR code, universal product code (UPC), international article number (EAN), or a data matrix reader which may read a code associated with a redemption request in order to retrieve a particular redemption request to monitor its status. Additionally or alternatively, the system may be configured such that a code associated with a particular good or service may be scanned in order to determine if there are any outstanding redemption requests for that particular good or service.

FIG. 6 is a screenshot 600 of a portion of an example user interface that provides a general overview of what workflow or workflow subroutines the entity has selected. FIG. 7 is a screenshot 700 of a portion of an example user interface that includes the preparation associated with fulfilling a redemption request. During this process, the user is able to see a listing of which redemption requests have been acknowledged 702 or received by the redemption system (e.g., redemption system 150 of FIG. 1), which has yet to be accepted or acknowledged 704 by the entity 130, and which stock 706 needs to be pulled or, in some instances, ordered in order to fulfill the requests.

FIG. 8 is a screenshot 800 of a portion of an example user interface by which a user is able to activate, suspend, or monitor a listing of various locations 802 owned or operated by the entity. In some instances, this may be where an inventory of goods is stored awaiting sale. By selecting a button 804, the user is able to edit settings associated with an entity. For example, the setting associated with the entity may include updating information, checking the available space or inventory, ordering or delivering additional stock, pulling stock for fulfilling redemption requests or the like.

FIG. 9 is a screenshot 900 of a portion of an example user interface that illustrates the various workflow operations associated with a pre-selected “In Store” portion of an example workflow process. In the example of FIG. 9, the entity 130 has selected a workflow process that includes scanning a received redemption request 902, identifying which goods or services are necessary to fulfill the redemption request 904, retrieving or redeeming the necessary goods and services 906, and receiving payment 908 for fulfilling the redemption request.

In some instances, a payment process may involve obtaining a payment from a customer who has elected to “pay at the time of pickup” if the entity elects to make this option available to customers. In other instances, the payment step may involve obtaining a customer signature. Finally, in other configurations, the payment step may involve sending a request to the sales module 132 operated by the redemption system to transfer the payment for the goods or services to an account of the entity in exchange for fulfilling the redemption request.

FIG. 10 is a screenshot 1000 of a portion of an example user interface that directs the user to which redemption requests have either expired or will shortly expire 1004. In addition, the portion of the example user interface enables the user to view previous redemption requests that have been cancelled 1002.

FIG. 11 is a screenshot 1100 of a portion of an example user interface associated with cancellation of a redemption request. In the portion included in the screenshot 1100, the user may elect whether a user of the system is prompted when cancelling a redemption request. Additionally, through interfacing with the portion included in the screenshot 1100, the user may elect whether a customer is notified when a cancellation from a customer is received. A button 1102 that may enable the user to edit and/or modify what the user prompt may be. A button 1104 may enable the user to edit and/or modify what the automated e-mail response should be. As previously described, once a user makes the desired elections, the preferences and settings may then be saved using a save button 1106 and the window may be closed using the close button 1108.

FIG. 12 is a screenshot 1200 of a portion of an example user interface that may enable an administrator or other authorized operators of a redemption system (e.g., the redemption system 150) to place expiration settings for a redemption request. Specifically, as shown in FIG. 12, the redemption system may display the portion of the user interface including the screenshot 1200 to the user that enables the user to make an election whether an inventory location is notified when a redemption request expires 1210. Additionally, the user may select a method of notifying the inventory location. Some example methods of notifying the inventory location may include, but are not limited to, an e-mail 1214 address which may be entered and/or edited.

Through interaction with the screenshot 1200, the user may also be able to elect whether the customer is notified when a redemption request expires 1212. For example, the user may select a radio button or other user input. After making the desired selections, the user may then save 1216 and close 1220 the window 1200.

As may be understood, the system and method described herein provide various benefits which are not currently found in the art. Specifically, the redemption system and methods described herein provide a redemption system which enables an entity to monitor and track the process of fulfilling orders for sales made through an existing or third party online, POS, or other sales system. The redemption system and method may operate as a SaaS based system so that the entities do not need to pay for customized software.

The embodiments described herein provide entities with a redemption system and solution that enables the entities to quickly and efficiently select a sales system customized to the needs of the entities, while offering the entities the inventory and workflow management. Additionally, the redemption system and method described herein is customizable, scalable, and can be easily changed as the demands of the entity change. As such, the redemption system and method described herein enable the entities to effectively operate with an inventory and redemption fulfillment system. In many instances, the system and methods described herein may enable smaller entities to better compete with larger competitors.

Any of the operations, processes, etc. described herein can be implemented as computer-readable instructions stored on a computer-readable medium. For example, the redemption system 150 and the entity 130 described in FIG. 1 may each operate using processors 158 and 138 and memories 152 and 146, respectively. These components may implement computer-readable instructions which can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In some embodiments, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof. Additionally, designing the circuitry and/or writing the code for the software and/or firmware is within the skill of those skilled in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or included components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

FIG. 13 shows an example computing device 1300 that is arranged to perform any of the computing methods described herein. In a basic configuration 1302, computing device 1300 generally includes one or more processors 1304 and a system memory 1306. A memory bus 1308 may be used for communicating between processor 1304 and system memory 1306.

Depending on the desired configuration, processor 1304 may be of any type including but not limited to a microprocessor (μP), a microcontroller (μC), a digital signal processor (DSP), or any combination thereof. Processor 1304 may include one more levels of caching, such as a level one cache 1310 and a level two cache 1312, a processor core 1314, and registers 1316. An example processor core 1314 may include an arithmetic logic unit (ALU), a floating point unit (FPU), a digital signal processing core (DSP Core), or any combination thereof. An example memory controller 1318 may also be used with processor 1304, or in some implementations memory controller 1318 may be an internal part of processor 1304.

Depending on the desired configuration, system memory 1306 may be of any type including but not limited to volatile memory (such as RAM), non-volatile memory (such as ROM, flash memory, etc.) or any combination thereof. System memory 1306 may include an operating system 1320, one or more applications 1322, and program data 1324. Application 1322 may include a determination application 1326 that is arranged to perform the functions as described herein including those described with respect to methods described herein. Program data 1324 may include determination data 1328 that may be useful for analyzing webpage rank within a search engine results page. In some embodiments, application 1322 may be arranged to operate with program data 1324 on operating system 1320 such that the work performed, such as the carrying out of the methods described, by untrusted computing nodes can be verified. This described basic configuration 1302 is illustrated in FIG. 13 by those components within the inner dashed line.

Computing device 1300 may have additional features or functionality, and additional interfaces to facilitate communications between basic configuration 1302 and any required devices and interfaces. For example, a bus/interface controller 1330 may be used to facilitate communications between basic configuration 1302 and one or more data storage devices 1332 via a storage interface bus 1334. Data storage devices 1332 may be removable storage devices 1336, non-removable storage devices 1338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 1306, removable storage devices 1336, and non-removable storage devices 1338 are examples of computer storage media. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 1300. Any such computer storage media may be part of computing device 1300.

Computing device 1300 may also include an interface bus 1340 for facilitating communication from various interface devices (e.g., output devices 1342, peripheral interfaces 1344, and communication devices 1346) to basic configuration 1302 via bus/interface controller 1330. Example output devices 1342 include a graphics processing unit 1348 and an audio processing unit 1350, which may be configured to communicate to various external devices such as a display or speakers via one or more A/V ports 1352. Example peripheral interfaces 1344 include a serial interface controller 1354 or a parallel interface controller 1356, which may be configured to communicate with external devices such as input devices (e.g., keyboard, mouse, pen, voice input device, touch input device, etc.) or other peripheral devices (e.g., printer, scanner, etc.) via one or more I/O ports 1358. An example communication device 1346 includes a network controller 1360, which may be arranged to facilitate communications with one or more other computing devices 1362 over a network communication link via one or more communication ports 1364.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 1300 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1300 may also be implemented as a personal computer including both laptop computer and non-laptop computer configurations. The computing device 1300 can also be any type of network computing device. The computing device 1300 can also be an automated system as described herein.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

For this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. It should also be recognized that any module or component described herein can implement the functionalities associated with the name of the module or component.

Functionally equivalent methods and apparatuses are within the scope of the disclosure, in addition to those enumerated herein. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

From the foregoing, embodiments described herein are for purposes of illustration. Various modifications may be made without departing from the present disclosure. Accordingly, the embodiments disclosed herein are not intended to be limiting.

What is claimed is:

1. A method of fulfilling a redemption request, the method comprising:
creating an offer for an entity, the offer being configured to incentivize a purchase of a good or a service of the entity;
distributing the offer to a plurality of customers via at least one e-commerce channel;
collecting payment for a purchase of the good or the service from a customer of the plurality of customers;
in response to collection of the payment, creating a redemption request; and
tracking the redemption request according to a customized workflow process of the entity, the customized workflow process including a plurality of subroutines selected by the entity.

2. The method of claim 1, wherein the offer includes a generic user offer that includes a generic redemption code configured for use by multiple customers of plurality of customers, the method further comprising:
receiving redemption by the customer of the generic redemption code at a time of purchase of the good or the service.

3. The method of claim 1, wherein the offer includes a template offer that includes generalized aspects and a unique offer uniform resource locator (URL), the method further comprising:
receiving an opt in message by the customer at the unique URL of the template offer;
generating a customer-specific offer that is tied to identifying information associated with the customer; and
receiving redemption by the customer of the customer-specific offer at a time of purchase of the good or the service,
wherein the customer-specific offer includes an association of the customer-specific offer with a credit card of the customer; and the redemption by the customer of the customer-specific offer includes a presentation of the credit card and a validation of the association between the customer and the credit card.

4. The method of claim 1, further comprising:
receiving an “in store pickup” selection from the customer, wherein the “in store pickup” selection is configured to indicate that the customer intends on picking up a purchased good at a location associated with the entity;
notifying the entity of a status of the redemption request;
notifying the customer that the purchased good is ready for pickup at the location; and
after pickup, determining that the redemption request is complete.

5. The method of claim 1, further comprising:
determining whether the entity fails to fulfill the redemption request; and
in response the entity failing to fulfill the redemption request, refunding the payment to the customer.

6. The method of claim 1, wherein the plurality of subroutines includes one or more of scanning the redemption request; identifying which goods or services are involved in fulfilling the redemption request; retrieving involved goods or services involved in fulfilling the redemption request; redeeming goods or services involved in fulfilling the redemption request; receiving payment for fulfilling the redemption request; obtaining a payment from a customer who has elected to “pay at the time of pickup”; obtaining a customer signature; sending a request to transfer the payment to a particular account; locating the necessary goods, ordering the goods in response to a determination that the goods are not currently in stock; retrieving the goods from a warehouse; ordering raw goods involved in generation of goods; delivering raw goods to an employee who creates goods; inspecting goods; packaging goods; shipping goods; identifying a service employee capable of performing a particular service; and monitoring a docket of a service employee.

7. The method of claim 1, further comprising:
enabling assignment of authorization rights to one or more operators; and
enabling modification of one or more subroutines of the plurality of subroutines based on an authorization right assigned to the one or more operator.

8. The method of claim 1, further comprising controlling inventory of the entity including monitoring inventory at one or more locations and controlling which of the one or more locations fulfills the redemption request.

9. The method of claim 1, further comprising temporarily storing the payment until an electronic transfer of the payment is completed and until the entity is determined to have fulfilled the redemption request.

10. The method of claim 1, wherein redemption request expires after a predetermined period of time, the method further comprising notifying the customer in response to the redemption request expiring.

11. A redemption system configured to connect with a sales module of an entity, the sales module being further configured to connect with a plurality of customers, the redemption system comprising:
a processor; and
a non-transitory computer-readable medium coupled to the processor and including computer-readable instructions stored thereon, which in response to execution by the processor, cause the processor to perform or cause the processor to control performance of operations comprising:
creating an offer for an entity, the offer being configured to incentivize a purchase of a good or a service of the entity;
distributing the offer to a plurality of customers via at least one e-commerce channel;
collecting payment for a purchase of the good or the service from a customer of the plurality of customers;
in response to collection of the payment, creating a redemption request; and
tracking the redemption request according to a customized workflow process of the entity, the customized workflow process including a plurality of subroutines selected by the entity.

12. The redemption system of claim 11, wherein:
the offer includes a generic user offer that includes a generic redemption code configured for use by multiple customers of plurality of customers; and
the operations further comprise receiving redemption by the customer of the generic redemption code at a time of purchase of the good or the service.

13. The redemption system of claim 11, wherein:
the offer includes a template offer that includes generalized aspects and a unique offer uniform resource locator (URL), the method further comprising:
receiving an opt in message by the customer at the unique URL of the template offer;
generating a customer-specific offer that is tied to identifying information associated with the customer;
receiving redemption by the customer of the customer-specific offer at a time of purchase of the good or the service; and
the customer-specific offer includes an association of the customer-specific offer with a credit card of the customer; and the redemption by the customer of the customer-specific offer includes a presentation of the credit card and a validation of the association between the customer and the credit card.

14. The redemption system of claim 11, wherein the operations further comprise:
receiving an “in store pickup” selection from the customer, wherein the “in store pickup” selection is configured to indicate that the customer intends on picking up a purchased good at a location associated with the entity;
notifying the entity of a status of the redemption request;
notifying the customer that the purchased good is ready for pickup at the location; and
after pickup, determining that the redemption request is complete.

15. The redemption system of claim 11, wherein the operations further comprise:
determining whether the entity fails to fulfill the redemption request; and
in response the entity failing to fulfill the redemption request, refunding the payment to the customer.

16. The redemption system of claim 11, wherein the plurality of subroutines includes one or more of scanning the redemption request; identifying which goods or services are involved in fulfilling the redemption request; retrieving involved goods or services involved in fulfilling the redemption request; redeeming goods or services involved in fulfilling the redemption request; receiving payment for fulfilling the redemption request; obtaining a payment from a customer who has elected to “pay at the time of pickup”; obtaining a customer signature; sending a request to transfer the payment to a particular account; locating the necessary goods, ordering the goods in response to a determination that the goods are not currently in stock; retrieving the goods from a warehouse; ordering raw goods involved in generation of goods; delivering raw goods to an employee who creates goods; inspecting goods; packaging goods; shipping goods; identifying a service employee capable of performing a particular service; and monitoring a docket of a service employee.

17. The redemption system of claim 11, wherein the operations further comprise:
enabling assignment of authorization rights to one or more operators; and
enabling modification of one or more subroutines of the plurality of subroutines based on an authorization right assigned to the one or more operator.

18. The redemption system of claim 11, wherein the operations further comprise controlling inventory of the entity including monitoring inventory at one or more locations and controlling which of the one or more locations fulfills the redemption request.

19. The redemption system of claim 11, wherein the operations further comprise temporarily storing the payment until an electronic transfer of the payment is completed and until the entity is determined to have fulfilled the redemption request.

20. The redemption system of claim 11, wherein redemption request expires after a predetermined period of time, the method further comprising notifying the customer in response to the redemption request expiring.
